(19) United States
(12) Patent Application Publication
(10) Pub. No.: US 2015/0028184 A1
(43) Pub. Date: Jan. 29, 2015

(54) UTENSIL HOLDER

(71) Applicant: DeAndre MOORE, Gardena, CA (US)

(72) Inventor: DeAndre MOORE, Gardena, CA (US)

(21) Appl. No.: 13/952,483

(22) Filed: Jul. 26, 2013

(51) Int. Cl. F16M 13/02

(52) U.S. Cl. CPC F16M 13/02
USPC 248/688

(57) ABSTRACT

A utensil holder has an enclosure having a hollow interior. An insertion point is formed in the enclosure for inserting a utensil into the hollow interior of the enclosure. An indentation is formed on a back surface of the enclosure for supporting the utensil when the utensil holder is positioned on a front surface of the enclosure.

### TECHNICAL FIELD

This provisional disclosure generally relates to utensils, and more particularly, to a device for securing utensils and other items in an aesthetically pleasing holder.

### BACKGROUND

Utensils, such as forks and spoons, can be used for eating. These have become important in the Western World. A combination of these utensils have been developed, for example, a spork (spoon/fork), spife (spoon/knife), knork (knife/fork) and sporf (spoon/knife/fork). The utensils are generally made of silver, plastic, metal or other material. These utensils can be cleaned and stored away.

Children, however, do not typically find the use of such utensils appealing. Especially in their infant years, children are generally stimulated from pictures such as animals. Furthermore, surfaces on which the utensils can rest contain bacteria and diseases potentially leading to illnesses.

A need therefore exists for a utensil holder that overcomes these, as well as other related, challenges.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a utensil holder is provided. The utensil holder can include having an insertion point for a utensil and a fastener for holding a straw. The enclosure can provide an indentation on a back surface for supporting the utensil.

In accordance with another aspect of the present disclosure, a utensil holding device is provided. The utensil holding device has an enclosure having a hollow interior. An insertion point is formed in the enclosure for inserting a utensil into the hollow interior of the enclosure. A fastener is formed on the enclosure for securing a tubular member on an exterior portion

In accordance with yet another aspect of the present disclosure, a utensil holder is provided. The utensil holder has an enclosure having a hollow interior. An insertion point is formed in the enclosure for inserting a utensil into the hollow interior of the enclosure. An indentation is formed on a back surface of the enclosure for supporting the utensil when the utensil holder is positioned on a front surface of the enclosure. A fastener is formed on the back surface of enclosure and in communication with the indention for holding a straw. A slot is formed on the enclosure for allowing water to be flushed through the enclosure.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a front portion of an exemplary utensil holder in accordance with one aspect of the present disclosure;

FIG. 2 is a back portion of the exemplary utensil holder of FIG. 1;

FIG. 3 is a top portion of the exemplary utensil holder of FIG. 1;

FIG. 4 is a bottom portion of the exemplary utensil holder of FIG. 1;

FIG. 5 is an interior portion of the exemplary utensil holder of FIG. 1;

FIG. 6 is an illustrative utensil on top of the exemplary utensil holder of FIG. 1 in accordance with one aspect of the present disclosure;

FIG. 7 is a front portion of the exemplary utensil holder of FIG. 1 having an illustrative straw attached thereto in accordance with one aspect of the present disclosure;

FIG. 8 is a side portion of the exemplary utensil holder of FIG. 7; and

FIG. 9 is a back portion of the exemplary utensil holder of FIG. 7.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the present disclosure to a utensil holder that provides multiple features. In an illustrative embodiment, the utensil holder can include an insertion point for securing a utensil. The utensil can also rest on a back portion of the holder preventing contact with a surface on which the holder rests. An indentation on the holder can support the utensil. The utensil holder can also hold a straw. A fastener can be provided on a back portion of the holder to securely fit the straw. A variety of aesthetically pleasing pictures can be provided on a front portion of the holder, for example, a monkey's face.

A number of advantages can be provided through the utensil holder. The holder can be easy to clean and provide a sanitary enclosure for a utensil. The holder can also provide a surface on which the utensil can rest when in use. Multiple designs can be provided which can entice a child as well as provide visual stimulation. Other advantages will become apparent from the discussion provided below.

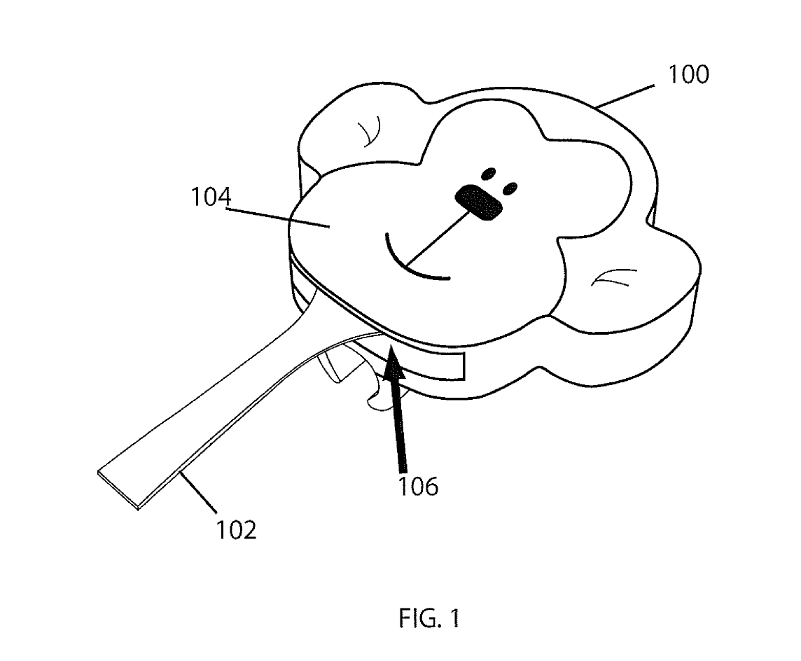

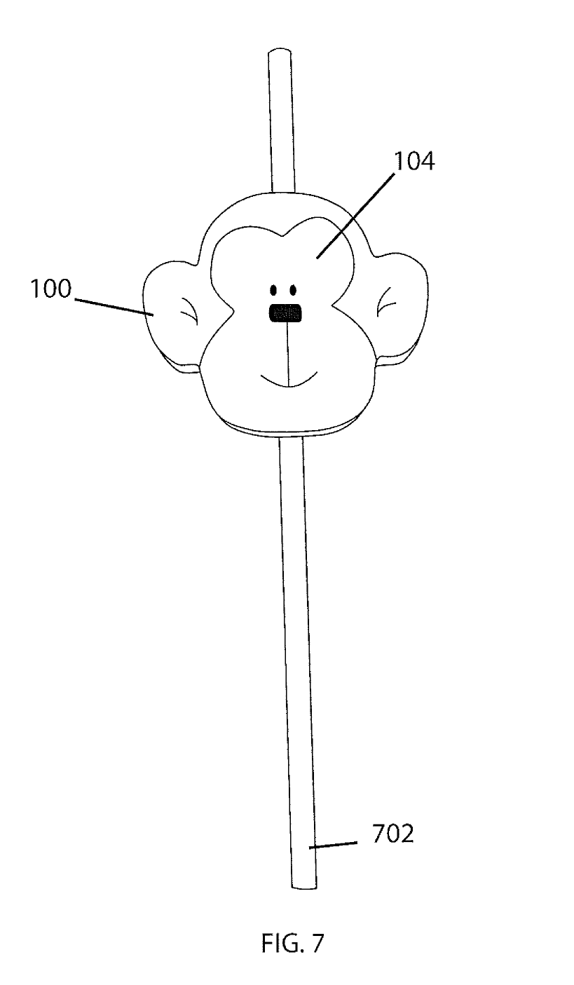

An exemplary utensil holder will be described in FIGS. 1 through 6. FIGS. 7 through 9 will provide an exemplary configuration for the utensil holder with a straw attached. For purposes of the present disclosure, the utensil can be a fork, knife, spoon or combination thereof. Other household items can be inserted into the holder and will become apparent from the description provided below.

Turning now to FIG. 1, a front portion of an exemplary utensil holder 100 in accordance with one aspect of the present disclosure is provided. The holder 100, in one embodiment, can incorporate a picture 104. The picture 104 can vary and depend on what appeals to the user. For example, animal characters can be used. Children can select the picture 104 they want and collect the holders 100. Typically, the picture 104 can be permanently placed on the holder 100.

In one embodiment, the picture 104 can be changed on the holder 100. Using hook and loop fasteners, the picture 104 can be manipulated. For example, instead of a monkey's face, the child can change the picture 104 to a giraffe's face. Stickers can also be used that define the picture 104 on the holder 100. The front portion of the holder 100 can be standardized such that different pictures 104 can be used. Those skilled in the relevant art will appreciate that there are number of ways to interchange pictures 104 and are not limited to those described above. The top portion of the holder 100 can also take on a variety of shapes.

The holder 100 can be made of a variety of materials and shapes. In the present embodiment, the holder 100 is shaped as a monkey's head. However, the holder 100 may be formed in other shapes without departing from the spirit and scope of the present invention.

Generally, the holder 100 can be flexible, but does not necessarily have to be. The holder 100 can be made of plastic, rubber, clay, etc. In one embodiment, the holder 100 can be made of a silicon based plastic or polymer. The holder 100 can be made from a single piece of material. While the holder 100 is shown as a single piece in FIG. 1, the holder 100 can come in multiple pieces. For example, a top portion and a bottom portion can be snapped or fastened together to form the holder 100.

At the bottom of the holder 100, an insertion point 106 can be provided. The insertion point 106 can be an opening through the holder 100 on a bottom portion of the holder 100. The insertion point 106 can be a narrow slit big enough to fit a utensil 102. The insertion point 102 can be located on other areas of the holder 100. In one embodiment, the insertion point 102 may be sized to allow one to insert the utensil 102 within the holder 100.

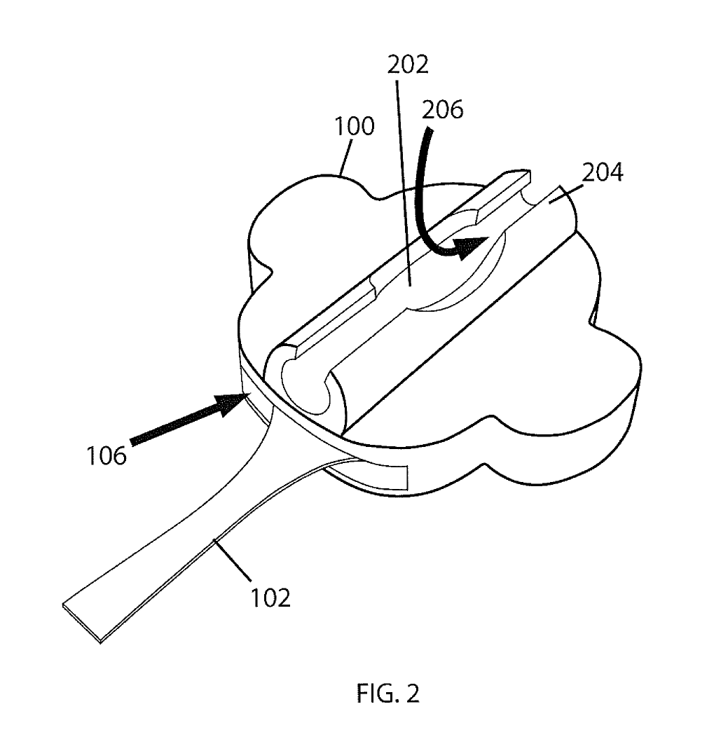

FIG. 2 is a back portion of the exemplary utensil holder 100 of FIG. 1. A picture, or at least a portion thereof, can be provided on the back of the holder 100, not shown. For example, a back of monkey's head can be placed on the back portion. The picture on the back portion can be interchanged. The picture can be placed on the holder 100 through hook and loop fasteners or be a sticker, as previously described.

On the holder 100, an indentation 202 can be provided. The indentation 202 can have the shape of the utensil 102 or at least a top portion thereof. For example, spoon indentations can be imprinted within the holder 100. The indentation 202 can allow the utensil 102 to rest thereon when the backside of the holder 100 is facing upwards. Through this, the holder 100 can provide a sterile environment where the user can rest the utensil 102 on.

As shown in FIG. 2, the holder 100 can also provide a second insertion point 206. The second insertion Point 206 can be formed by a fastener 204 located at the top of the holder 100. The fastener 204 can be completely encircled as shown or can have a slit in the middle. For purposes of illustration, a straw or tubular member can be inserted through the second insertion point 206, which will be described in FIGS. 7 through 9.

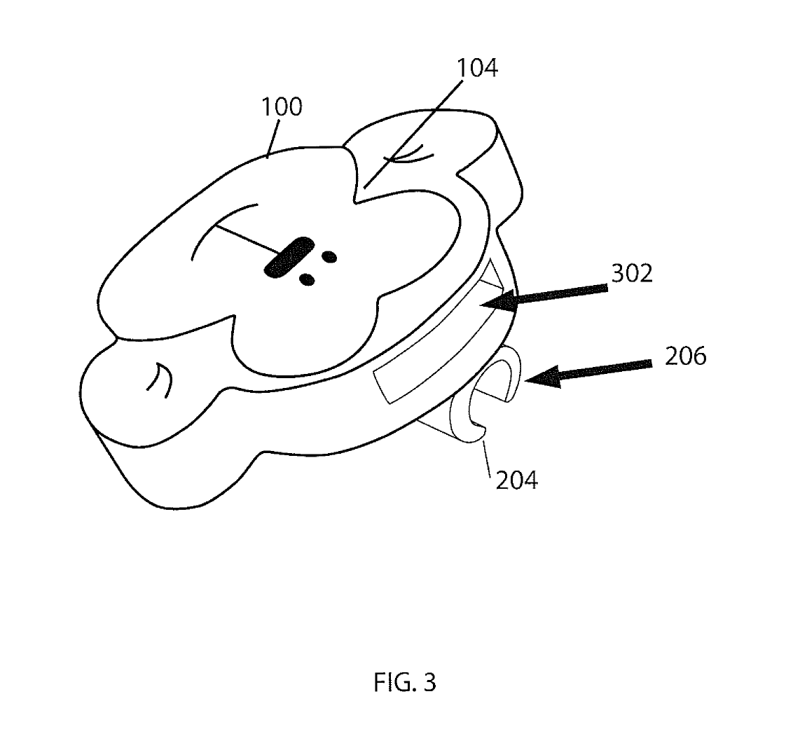

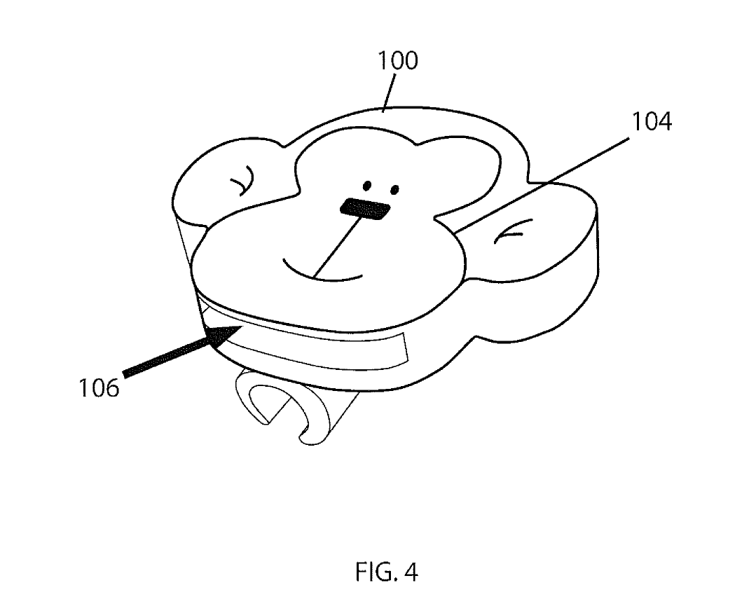

Referring to FIG. 3, a top portion of the exemplary utensil holder 100 of FIG. 1 is provided. The second insertion point 206, as shown, can be encircled by the fastener 204. A slot 302 can also be depicted. Some utensils 102 can extend therethrough. The slot 302 can be used to clean the holder 100 by flushing it with water. FIG. 4 is a bottom portion of the exemplary utensil holder 100 of FIG. 1.

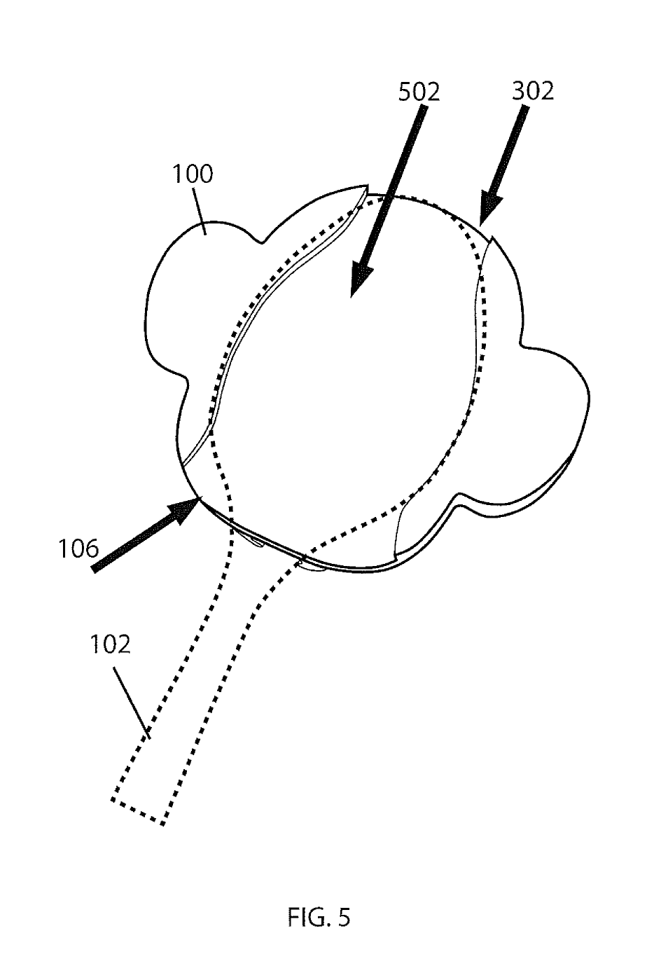

FIG. 5 is an interior portion 502 of the exemplary utensil holder 100 of FIG. 1. The utensil 102 can be fitted into the insertion point 106. A portion of the utensil 102 can extend through the slot 302 at the top of the holder 100. Generally, the interior portion 502 can be the shape of the utensil 102. For example, the interior portion 502 can be curved when a spoon is placed therein or straight when a fork is used. Those skilled in the relevant art will appreciate that there are numerous types of interior portions 502 that can be available dependent on the utensil 102 used.

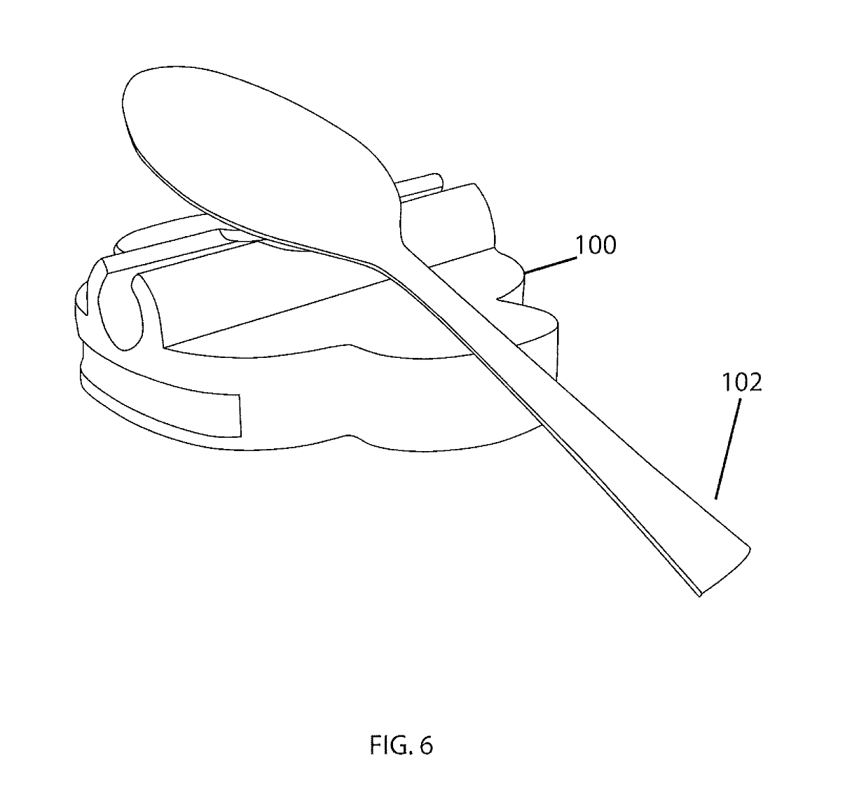

FIG. 6 is an illustrative utensil 102 on top of the exemplary holder 100 of FIG. 1 in accordance with one aspect of the present disclosure. The utensil 102, on one end, can contact the surface on which the holder 100 lies on. On the other end, the utensil 102 can rest on top of the holder 100 at a slanted angle and positioned upwards. The eating surface on the utensil 102 therefore never touches the surface on which the holder 100 is placed.

Referring to FIG. 7, a front portion of the exemplary utensil holder 100 of FIG. 1 having an illustrative straw 702 attached thereto in accordance with one aspect of the present disclosure is provided. The straw 702 can fit into the fastener 204 through the insertion point 206. In one embodiment, the fastener 702 does not have to be completely enclosed. Instead, the fastener 204 can provide a slit whereby the straw 702 can be pushed through and secured. Because the straw 702 can be made of plastic, side portions of the straw 702 can bend and snap into place. More than one fastener 204 can be provided to secure the straw 702.

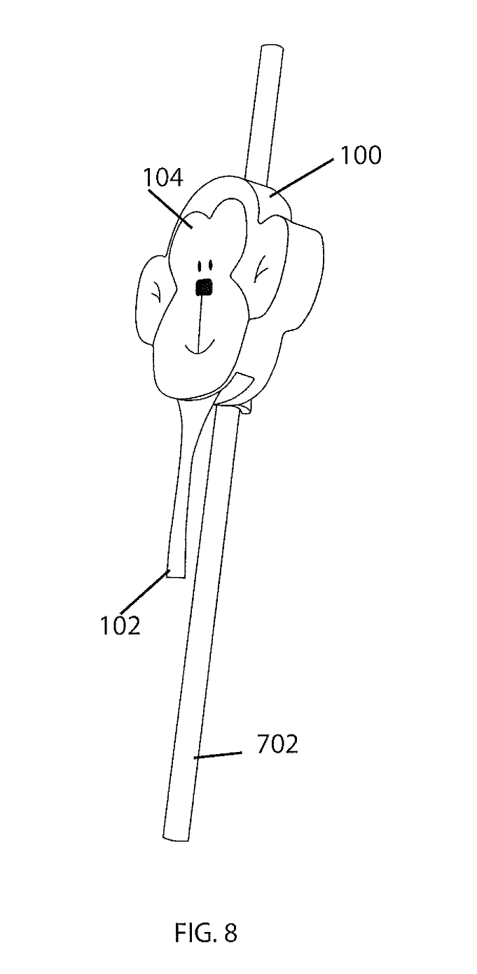

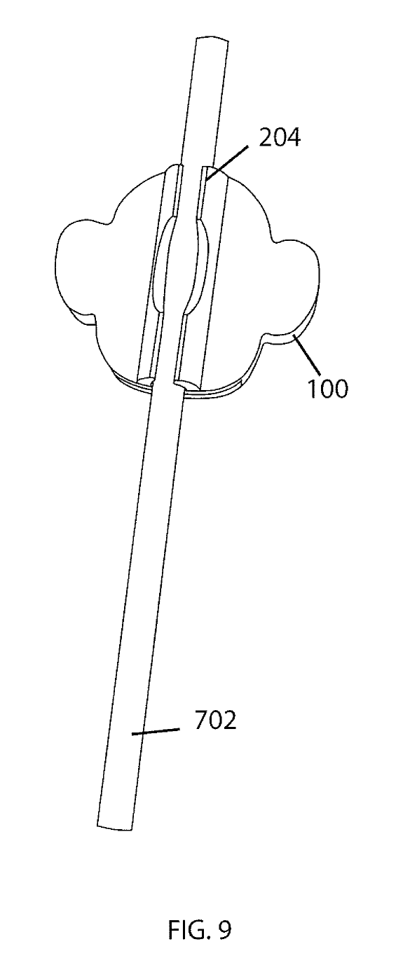

FIG. 8 is a side portion of the exemplary utensil holder 100 of FIG. 7. As shown, the utensil 102 and straw 702 can be placed within the holder 100 at the same time. The holder 100 can be easily carried. The holder 100 also removes the use of touching any of the items that can be connected thereto. FIG. 9 is a back portion of the exemplary utensil holder 100 of FIG. 7.

While one utensil 102 and a straw 702 were shown within the holder 100, other configurations can be provided and are within the scope of the present disclosure. For example, two fasteners 204 can be provided for chopsticks. The chopsticks can be inserted into the fasteners 204 along with a spoon that can be inserted through the insertion point 106 of the holder 100. In one embodiment, the holder 100 can have lights or sounds associated with it. The sounds can be those created by the animals that are shown on it. The holder 100 can have a variety of sounds and dependent on the picture 104 placed thereon can be switched through known techniques.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A utensil holder comprising:
an enclosure having a hollow interior;
an insertion point formed in the enclosure for inserting a utensil into the hollow interior of the enclosure; and
an indentation formed on a back surface of the enclosure for supporting the utensil when the utensil holder is positioned on a front surface of the enclosure.

2. The utensil holder of claim 1, further comprising a fastener formed on the enclosure for holding a straw.

3. The utensil holder of claim 1, further comprising a fastener formed on the back surface of enclosure and in communication with the indention for holding a straw.

4. The utensil holder of claim 1, further comprising a slot formed on the enclosure for allowing water to be flushed through the enclosure.

5. The utensil holder of claim 1, wherein the enclosure is shaped like a head of an animal.

6. The utensil holder of claim 1, further comprising a picture on the front surface of the enclosure.

7. The utensil holder of claim 6, wherein said picture is an animal's head.

8. A utensil holding device comprising:
an enclosure having a hollow interior;
an insertion point formed in the enclosure for inserting a utensil into the hollow interior of the enclosure; and
a fastener formed on the enclosure for securing a tubular member on an exterior portion.

9. The utensil holding device of claim 8, further comprising an indentation formed on a back surface of the enclosure for supporting the utensil when the utensil holding device is positioned on a front surface of the enclosure.

10. The utensil holding device of claim 9, wherein the fastener is formed on the back surface of enclosure and in communication with the indention.

11. The utensil holding device of claim 8, further comprising a slot formed on the enclosure for allowing water to be flushed through the enclosure.

12. The utensil holding device of claim 8, wherein the enclosure is shaped like a head of an animal.

13. The utensil holding device of claim 8, further comprising a picture on the front surface of the enclosure.

14. The utensil holding device of claim 13, wherein the picture is an animal's head.

15. A utensil holder comprising:
an enclosure having a hollow interior;
an insertion point formed in the enclosure for inserting a utensil into the hollow interior of the enclosure;
an indentation formed on a back surface of the enclosure for supporting the utensil when the utensil holder is positioned on a front surface of the enclosure;
a fastener formed on the back surface of enclosure and in communication with the indention for holding a straw; and
a slot formed on the enclosure for allowing water to be flushed through the enclosure.

16. The utensil holder of claim 15, wherein the enclosure is shaped like a head of an animal.

17. The utensil holder of claim 15, further comprising a picture on the front surface of the enclosure.

18. The utensil holder of claim 17, wherein said picture is an animal's head.

19. The utensil holder of claim 15, wherein the indention is formed in a shape of the utensil.
